(19) United States
(12) Patent Application Publication
(10) Pub. No.: US 2005/0083455 A1
(43) Pub. Date: Apr. 21, 2005

(54) Spatially integrated display and memory system

(76) Inventor: David B. Chung, Cupertino, CA (US)

Correspondence Address: KENYON & KENYON, 1500 K STREET, N.W., SUITE 700, WASHINGTON, DC, 20005, US

(21) Appl. No.: 10/685,453

(22) Filed: Oct. 16, 2003

(51) Int. Cl. G02F 1/1335; G02F 1/135

(52) U.S. Cl. 349/113; 349/25

(57) ABSTRACT

A polymer memory system stores digital data in dipole moments of polymer memory cells. Apparatus is disclosed having polymer memory cells provided within an LCD display chamber. Embodiments provide for a high degree of integration the polymer memory system and a display system by providing polymer memory cells within the chamber. The memory cells may be located in non-viewable regions of the chamber. Thus, the memory cells provide only limited interference with the image-bearing functions of the display (if they interfere at all) but provide an extra dimension of functionality to the display.

### BACKGROUND

Embodiments of the present invention relate to memory systems that are integrated with LCD displays.

Battery-powered processing devices are subject to several different competing design criteria. For example, increasing the processing power of a computer's central processing unit or the amount of RAM memory provided thereon generally causes a corresponding increase in the rate at which the computer consumes power. Engineers are constantly challenged to design devices that provide increased processing power and increased storage capacity while, at the same time, prolonging battery life and decreasing the physical dimensions of those devices. Engineers are most acutely aware of these design constraints when designing processing systems for mobile applications, such as notebook computers, portable digital assistants, mobile phones, global positioning system (“GPS”) devices, automotive systems and other battery-powered devices.

Substantial research and development is underway in the area of polymer memories. Polymer memories are unlike traditional silicon-based RAM devices because, as their name implies, they are manufactured from polymers. Individual memory cells include a polymer material having a dipole moment. The orientation of the dipole moment may be controlled selectively to represent stored data. Polymer memories can be advantageous for battery-powered devices because stored data remains valid even when power is removed from the memory system.

The inventors have investigated polymer memories for battery-powered processing devices and have identified a need in the art for such a processing device that integrate polymer memories therein without increasing the form factor of the device.

### BRIEF DESCRIPTION OF THE DRAWINGS

FIG. 1 is a simplified block diagram of a spatially integrated display and memory system, according to an embodiment of the present invention.

FIG. 2 illustrates an array of pixels in a common display.

FIG. 3 illustrates an array of memory cells according to an embodiment of the present invention.

FIG. 4 illustrates a plurality of memory cells according to an embodiment of the present invention.

FIG. 5 is a block diagram of a computer system according to an embodiment of the present invention.

### DETAILED DESCRIPTION

According to embodiments of the present invention, greater integration may be achieved between a polymer memory system and a display system. Conventionally, LCD displays and the like define a number of liquid crystal chambers that include transmissive and non-transmissive regions. Polymer memory cells may be disposed within the chambers co-located with the non-transmissive regions thereof. Thus, the memory cells provide only limited interference with the image-bearing functions of the display (if they interfere at all) but provide an extra dimension of functionality to the display.

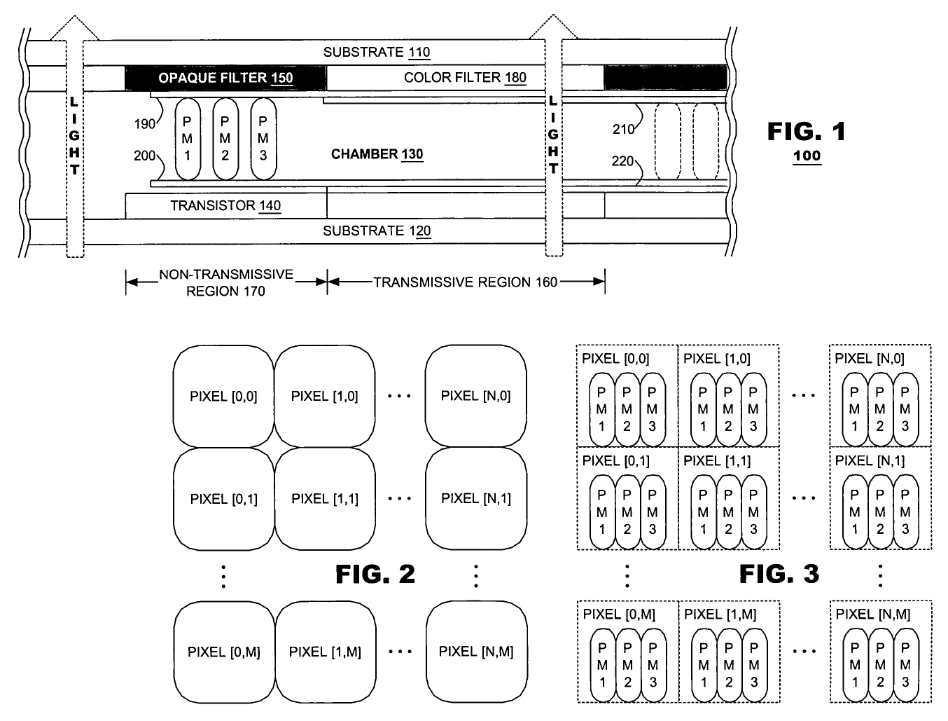

FIG. 1 is a simplified diagram of a display 100 according to an embodiment of the present invention. The display may include a pair of planar substrates 110, 120 that provide mechanical support to the display 100. The substrates 110, 120 generally are separated from one another and joined by various seals or spacers (not shown). Thus, mechanical elements within the display 100 form a chambers 130 across the display 100 into which liquid crystal materials are provided. Thin film transistors (TFTs) 140 controls the liquid crystal material at various spatial position across the chamber 130, creating pixels that are selectively opaque or transmissive to light. Thus, controlling the various TFTs 140 causes the display 100 to display image information. TFTs 140 may be provided with associated capacitors (not shown) that maintain the orientation of the LCD material when the TFTs 140 are not actively driven. In this regard, the structure and operation of an LCD display is well known.

Conventionally, LCD displays 100 include a variety of polarizing filters and other optical elements that contribute to the displays' ability to carry image information. Such structures may be used cooperatively with the various embodiments of the present invention; they are omitted from the illustration of FIG. 1 for simplicity's sake. An opaque filter 150 may be provided in an area that is generally co-extensive with the TFT 140 to provide optical isolation of the TFT from ambient or transmitted light. Thus, the area of a pixel may be divided into at least one a transmissive region 160 representing the observable area of the pixel and a non-transmissive region 170. Non-transmissive regions 170 of conventional LCD displays are too small to be detected by the human eye. In a color display, a pixel may include three non-transmissive regions and three transmissive regions. Each transmissive region may include a color filter 180 (typically, red, green and blue); each non-transmissive region 170 would be occupied by its own TFT. Only one set of transmissive and non-transmissive regions 160, 170 are shown in FIG. 1. In this regard, the operation of displays is well known.

Embodiments of the present invention introduce a polymer memory system into a chamber 130 of a display 100. Polymer memory cells PM1, PM2, PM3 may be disposed in one or more non-transmissive regions 170 of the display 100. Three such cells are shown in the illustrated embodiment but the number may be tailored to suit individual implementation needs. Because the polymer memory cells PM1, PM2, PM3 appear in a non-transmissive area of the display, they should provide limited interference, if any, to the optical performance of the display 100.

The display 100 may include control lines 190, 200 to provide electrical connectivity between the polymer memory cells PM1, PM2, PM3 and devices external to the display 100 (not shown). As indicated, the conductivity of a polymer memory cell may be controlled to represent digital data. Thus, when a predetermined potential is applied to a ‘supply line’ on a first portion of the polymer memory cell, the presence or absence of a current on a ‘return line’ on a second portion of the cell may indicate a state of stored data. In an embodiment having a predetermined number N of the cells in a chamber, there may be N supply conductors 190 (not shown individually) and a single return conductor 200 or there may be a single supply conductor 190 and a N return conductors 200 (again, not shown individually) to permit individual addressing of the polymer memory cells within the chamber 150. Other embodiments permit the supply and return conductors 190, 200 to be aligned with but insulated from addressing conductors 210, 220 that drive the transistor 140 and LCD materials, to minimize the profile of all the conductors 190, 200, 210 and 220 with reference to light propagating through the display 100.

The display structure 100 of FIG. 1 is representative of a wide variety of LCD display cells. Some LCD displays, such as those conventionally used in laptop monitors and flat panel displays, include a backlight (not shown) provided behind the display 100 when considered from the perspective of the viewing surface of the display. Other displays are not backlit. They rely on ambient light entering the display 100 from the viewable surface of the display, passing through the display to a reflective surface provided behind it and passing through the display a second time back toward the viewable surface. Commonly, non-lit monochromatic LCD displays are constructed in this manner, although similar designs for color LCD displays are available. Still other displays are “transflective;” they may toggle between backlit and reflective mode of operation. The principles of the foregoing embodiments find application with both backlit and reflective LCD displays.

FIG. 2 represents an array of pixel elements that may be present in an LCD display. In the embodiment shown, the pixels are provided in a regular array of N columns and M rows. FIG. 3 illustrates an exemplary array of polymer memory cells that may be co-located with the pixels of FIG. 2.

In many applications, it can be expected that there will be no electrical interference between electrical components of the display's optical elements (e.g., the TFTs 140 and addressing conductors 200, 210 and the polymer memory system provided therein. Particularly where the TFT transistors 140 are fairly large and the driving potentials for the LCD materials are fairly low, operation of these elements should not interfere with reading and writing operations of the memory system. Accordingly, memory addressing operations and pixel addressing operations can be performed without regard for one another.

According to other embodiments of the present invention, however, it may be desired to stagger memory addressing operations in time with respect to addressing operations for co-located TFTs 140 to ensure noise immunity. In an active matrix display, each pixel is addressed individually by its own set of addressing wires. Thus, image information for a pixel at coordinates [0,0] (FIG. 2) may be written to the pixel's transistor (not shown) whenever it is available, without regard to whether data is being written to neighboring pixels at the same time. Typically, the data is refreshed periodically even when the data has not changed over a prior value. For example, pixels may be refreshed 60 times per second. No matter whether the pixel is addressed sporadically or at some predetermined period, memory accesses to co-located memory cells may be deferred until some time when the pixel is no longer actively addressed.

Typically, the time required to write data to a transistor in an LCD display is a very small percentage of the display's refresh time. In a display that refreshes image information at least 60 times per second (a frame period of 16.7 ms), it may require only 10-20 ns to write data to a single TFT or a row of TFTs. Such data transfer times will only decrease as pixel driving technologies improve. Thus, a large percentage of the operational time of the display remains available for memory accesses.

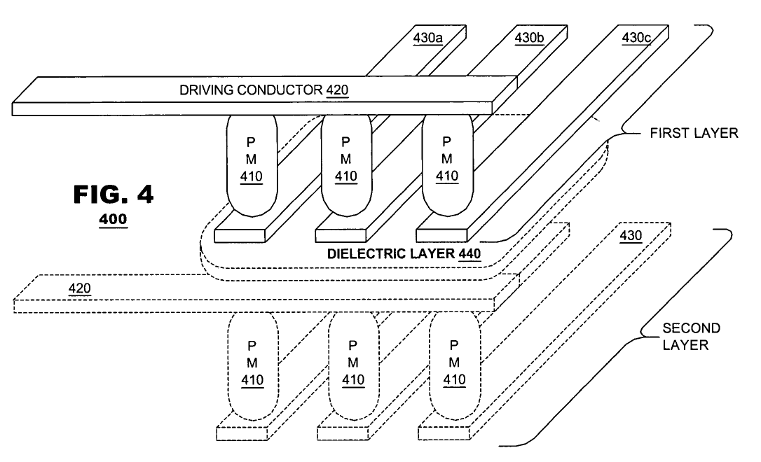

FIG. 4 illustrates the architecture of a polymer memory system 400 according to an embodiment of the invention. The memory system 400 may include a plurality of memory cells 410 provided between a driving conductor 420 and a plurality of data conductors 430. The polymer materials of the cells 410 themselves are characterized by a dipole moment, whose orientation can be controlled to represent stored information. During a reading operation, a driving potential may be applied to the driving conductor 420. The orientation of the dipole moment of each cell 410 may cause a current to be generated (or not) on an associated data conductor 430a-430c. A sense amplifier (not shown) provided on a terminal end of each data conductor 430 may detect the presence or absence of current thereon as binary data.

The capacity of a polymer memory system 400 may be increased by providing a plurality of layers of memory cells 410 in the polymer memory system 400. Accordingly, in an embodiment, the memory system 400 may include a plurality of layers (only two are shown in FIG. 4), where each layer includes an array of memory cells 410, a set of driving conductors 420 and a set of data conductors 430. Layers may be separated from each other by an interstitial insulative layer 440 to mitigate noise effects that might extend from one layer to the next.

The layers need not be provided identically to one another. For example, rather than stack individual cells 410 directly on top of one another, a cell in one layer may be placed in a location that is occupied by a space between cells in another layer. Further, a driving conductor 420 from one layer need not run parallel to driving conductors 420 from other layers. Similarly, data lines 430 from one layer need not run parallel to data lines 430 from another layer. Additionally, rather than providing a driving conductor 420 from one layer adjacent to data lines 430 of another layer, it may be beneficial to provide driving conductors 420 from each layer in an adjacent relationship or data lines 430 from each layer in an adjacent relationship. Such embodiments are within the spirit and scope of the present invention.

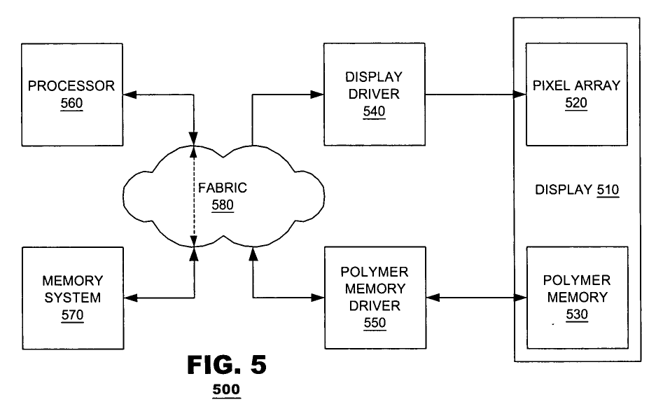

FIG. 5 illustrates a processor-based system 500 in which, according to an embodiment, the foregoing embodiments of a display may be applied. The system may include a display 510 having a pixel array 520 and spatially co-mingled polymer memory cells 530. The system 500 may include a display driver 540 and memory driver 550. As these names imply, the display driver 540 controls the pixel array 520 of the display 510 and causes it to display image information. The memory driver 550 controls the polymer memory system 530 of the display 510, causing it to read or write data. The display driver 550 may include driving circuits to and sense amplifiers to generate potentials on the control lines and to sense currents on the data lines of the earlier embodiments. According to an embodiment, the display driver 540 and memory driver 550 may be provided as conventional integrated circuits on an expansion card or the like of a larger processor-based system, to be accessed by one or more processors 560, a silicon-based memory system 570 or other integrated circuits via communication links (shown generally as “fabric” 580).

The polymer memory systems of the foregoing embodiments may be provided as general purpose random access memory (“RAM”) for storage of any kind of data to be used by a processor-based system 500. As is known, polymer memories are non-volatile; stored data remains valid in the memory even after power is removed. Thus, polymer memories are expected to find ready application in a variety of battery-powered processor-based systems 500, such as laptop/notebook computers, personal digital assistants, mobile phones and the like. By storing application data in a polymer memory, one may avoid many power-intensive operations such as loading an operating system on device start-up from a mechanical storage device such as a magnetic or optical disc. The present invention permits a large scale memory system to be integrated into a display to be used in such systems with almost no increase in the physical dimensions of the display.

Additionally, depending on the physical dimensions of the display system being used, the polymer memory system of the foregoing embodiments have the capability to replace certain bulk storage devices currently being used in computer systems, such as magnetic or optical disk drives. Generally, designers of a great many components in computer systems face constant pressure to reduce the physical size of such components. This design pressure, however, is not always applied to displays. For example, a variety of laptop/notebook computers are currently are marketed with display dimensions of 14 to 15 inches across the diagonal. Thus, by integrating the polymer memory system with the spatial area available for most LCD displays, one may create a memory system with relatively large capacity.

While the polymer memory system may store data that is used by the LCD display (for example, graphics data), this need not be the case. As noted above, the polymer memory system may be used for storage of any data that may be stored by other conventional RAM circuits.

Several embodiments of the present invention are specifically illustrated and described herein. However, it will be appreciated that modifications and variations of the present invention are covered by the above teachings and within the purview of the appended claims without departing from the spirit and intended scope of the invention.

1. A display, comprising:
a chamber to store a volume of liquid crystal material, the chamber having a viewable region and a non-viewable region, and
at least one polymer memory cell provided in a non-viewable region of the chamber.

2. The display of claim 1, further comprising a pixel transistor also located in the non-viewable region of the chamber, and separate sets of control lines for each of the polymer memory cell and the pixel transistor.

3. The display of claim 2, wherein the control lines are provided in one or more stack of control lines to reduce a profile of the control lines when considered from a viewable area of the display.

4. The display of claim 1, further comprising a backlight provided on an exterior surface of the display.

5. The display of claim 1, further comprising a reflector provided on an exterior surface of the display.

6. The display of claim 1, further comprising an opaque filter coincident with the non-viewable region of the display.

7. A display comprising:
a chamber to store liquid crystal material,
a plurality of display transistors arranged in an array across a planar surface of the chamber, the display transistors to define pixels of the display,
a memory system having polymer memory cells provided within the liquid crystal chambers.

8. The display of claim 7, wherein the chamber includes viewable and non-viewable regions and the memory cells are co-located with a non-viewable region thereof.

9. The display of claim 7, wherein polymer memory cells are co-located with the display transistors.

10. The display of claim 7, wherein the polymer memory system comprises:
a plurality of memory cells,
a driving line coupled to each of the cells, and
a plurality of data lines, one coupled to each of the cells.

11. The display of claim 7, wherein the polymer memory system comprises a plurality of layers, each layer comprising:
a plurality of memory cells,
a driving line coupled to each of the cells in the respective layer, and
a plurality of data lines, one coupled to each of the cells in the respective layer.

12. The display of claim 7, further comprising a backlight coupled to one surface of the display.

13. The display of claim 7, further comprising a reflector coupled to one surface of the display.

14. The display of claim 7, wherein each chamber comprises:
liquid crystal material provided within the chamber,
a pixel transistor coupled to a first control line on a first surface of the chamber, and
a second control line provided on a second surface opposite the first surface.

15. A computer system comprising: a processor, a memory system and an LCD display, each coupled together via a communication fabric, wherein the memory system includes polymer memory cells distributed among LCD materials of the display.

16. The system of claim 15, wherein the memory system comprises:
a plurality of polymer memory cells,
a driving line coupled to each of the polymer memory cells, and
a plurality of data lines, one coupled to each of the polymer memory cells.

17. The system of claim 15, wherein the memory system comprises a plurality of layers, each layer comprising:
a plurality of polymer memory cells,
a driving line coupled to each of the polymer memory cells in the respective layer, and
a plurality of data lines, one coupled to each of the polymer memory cells in the respective layer.

18. A method, comprising addressing a display system and reading data therefrom.

19. The method of claim 18, further comprising addressing the display system providing graphics data to the display.

20. The method of claim 19, wherein addressing of a memory cell within a display is staggered in time from addressing of a co-located pixel of the display.
